(19) United States
(12) Patent Application Publication
(10) Pub. No.: US 2009/0083928 A1
(43) Pub. Date: Apr. 2, 2009

(54) Tool for Finishing Inside Drywall Corners with Arcuate Blade Members

(76) Inventor: Larry Salvino, Wauconda, IL (US)

Correspondence Address: VEDDER PRICE P.C., 222 N. LASALLE STREET, CHICAGO, IL, 60601, US

(21) Appl. No.: 11/866,053

(22) Filed: Oct. 2, 2007

(51) Int. Cl. B05C 17/10; E04B 1/68

(52) U.S. Cl. 15/235.7; 52/741.41

(57) ABSTRACT

A tool for finishing viscous masses, such as joint compound and tape, for inside corners of drywall edges includes arcuate blade members. The arcuate blade members provide for the effective manipulation of the tool while moving upwardly or downwardly in an inside corner without the requirement of changing the tool to another hand of the user or inverting it to complete the finishing of the corner.

### BACKGROUND OF THE INVENTION

1. Field of the Invention

This invention relates to a tool for finishing drywall surfaces, and more specifically, a handheld tool designed for finishing drywall surfaces where the surfaces are the inside of a corner.

2. Description of the Prior Art

Drywall is a sheet of compressed gypsum-like material sandwiched between two sheets of heavy paper. The product, which typically is produced in a certain size, for example, 4 foot by 8 foot sections, is used efficiently and inexpensively to create interior walls in buildings. A smooth plaster like appearance is desired when installing the drywall. The rough seams between contiguous sheets of the drywall must be covered as well as the corners where sheets meet to form an angle. Both of these areas must be finished so that they have the appearance and smoothness of plaster. Drywall seams are typically taped and thereafter a taping or finishing compound is then smoothed over the taped area to render a smooth surface so that the seam appears to disappear. It is difficult to apply the finishing compound in a corner. Conventionally, there are trowels for smoothing the joint compound used on drywall or gypsum board panels that comprise a thin sheet metal member that is bent along a midline to define two planar surfaces meeting at a fixed 90° angle and up to a 103° angle. A handle is affixed to the sheet metal member to facilitate the positioning of the trowel in a corner joint and drawing it along the corner joint as joint compound is applied. The trowels are used for finishing defined internal corners where drywall meets as well as for finishing external corners. Both internal corner and external corner trowels may be used at the top of the joining of the sidewalls, for example, near a ceiling, and moved downwardly to the bottom of the joining of the sidewalls to the floor of the structure. In the movement of the trowel from top to bottom, the user must stop at some point along the corner joint to remove the trowel from the corner joint and place it upside down so that the top of the trowel is pointing towards the floor or lower sidewall members to continue the finishing process to the lower sidewall members or floor. This procedure takes extra time and skill to smooth any accumulation of joint compound where the trowel is lifted off the corner and replaced on the corner in an inverted position to continue the finishing process. It would be advantageous to have a trowel for applying drywall joint compound that is capable of being positioned and moved from the top of the corner joint all the way to the bottom of the joint without the necessity of removing the trowel from contact with the corner joint and repositioning it to continue the finishing process.

### SUMMARY OF THE PRESENT INVENTION

In accordance with the present invention, an improved tool is provided for finishing drywall surfaces, particularly where the surfaces are joined to form an inside corner. The tool has blade members defining an arcuate blade angle and a handle. This construction allows for the effective manipulation of the tool so that the user does not have to change the grip or change hands grasping the handle to move the tool from one end of an inside corner to another end of an inside corner, for example, the motion of moving the tool from the corner near the top of where the walls meet to the bottom of the corner. The tool does not have to be inverted by the user to reach the lower corner because of the arcuate edge of the blade members and handle. The top edge of the arcuate blade edge is utilized at the top of an inside corner and, as the tool is moved downwardly in the corner, the blade is rotated so it remains in contact with the joint tape, joint adhesive or mud and inside corners. As the arcuate blade is moved past a midpoint in the corner, the blade is rotated so the bottom edge of the arcuate blade remains in contact with the inside corner to finish it all the way to the floor.

It is an object of the present invention to provide an effective tool for finishing inside drywall corners without the need to invert the tool or having the user change the tool to another hand or reposition the tool for completion of the finishing of the corner.

It is another object of the present invention to provide blade members that define the blade angle for finishing a corner of drywall. The tool can be provided to fit different corner angles, as well as the ceiling and wall joints.

These and other objects and advantages of the present invention, as well as details of an illustrative embodiment, will be more fully understood from the following description and from the drawings.

### BRIEF DESCRIPTION OF THE DRAWINGS

The present invention will be understood and appreciated more fully from the following detailed description taken in conjunction with the drawings in which:

FIG. 1 is a perspective view of one embodiment of the present invention showing the arcuate blade and handle;

FIG. 2 is a side view of one embodiment of the present invention showing the apex of the arcuate blade member and respective angles of the edges of the blade and handle;

FIG. 3 is another perspective view of one embodiment of the present invention;

FIG. 4 is a representation of a side view of an embodiment of the present invention for finishing joint compound on drywall wherein the embodiment is positioned so that it may proceed from the top of the drywall joint to the bottom of the drywall joint so that it remains in contact with the joint compound and drywall corner so that it finishes the corner without being removed therefrom;

### DETAILED DESCRIPTION OF THE PREFERRED EMBODIMENTS

The present invention provides, among other things, a new and improved apparatus for distributing joint compound or other similar adhesive-type viscous mass to an inside surface corner. The embodiments of the present invention are easy to use and construct and prove exemplary for facile and efficient distribution of the joint compound or viscous mass to surface corners.

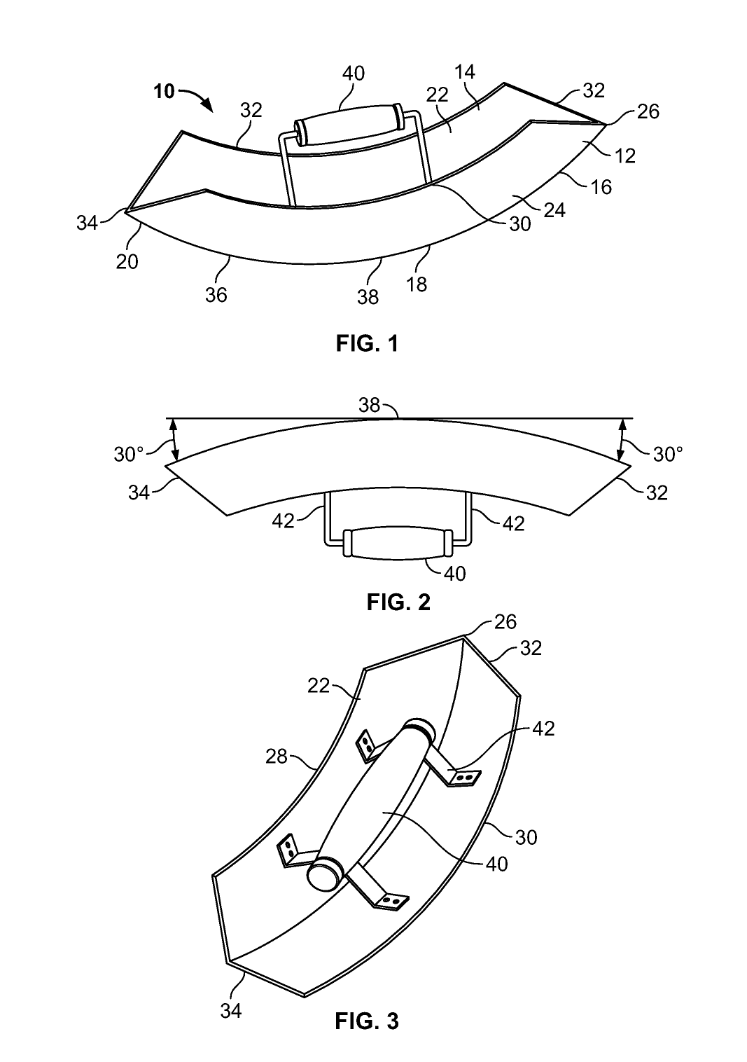

Turning now to the drawings, in which like reference characters indicate corresponding elements throughout the several views. Attention is first directed to FIGS. 1-3, which illustrate perspective and side views of tool 10 for distributing a viscous mass, for example, joint compound, taping compound or adhesive to an inside surface corner. The tool of the present invention is capable of applying the joint compound, also known as taping or finishing compound or “mud,” in a smooth and uniform layer to mask the rough edges of a corner and any tape that may have been applied to the seam or joint formed from the meeting of two wallboard pieces to form a corner. The finishing also covers staples or nails and provides smoothness to the surface area.

Tool 10 includes first 12 and second 14 blade members for spreading the joint compound or other viscous mass. Blade members 12 and 14 have an upper portion 16, midportion 18, and lower portion 20. They have a first or inner side 22 and a second or outer side 24. The blade members are typically constructed of sheet metal or other suitable metal or rigid plastic or rubber.

Blade members 12 and 14 meet at joint 26, which forms the desired angle for finishing a corner joint. The tool 10 may be constructed to finish inside angles where wallboard meets to form a corner. The angle of the joint may vary. The tool can be used with wallboard, vanities, ceilings, and ceiling and wall joints. It may also be used with masonry products for forming angles, steps, arches, and the like. Tool 10 can be constructed to be operatively associated with various corner angles. With no intention of being limitative, the illustrations show embodiments of the present invention having a joint angle of about 30°. Blade 10 includes outside edges 28 and 30 of the blades and top edge 32 and bottom edge 34 of the blades 12 and 14.

In order to accomplish the objectives of the invention, it is necessary that tool 10 has blade members 12 and 14 forming an arcuate angle 36 at joint 26. Arcuate angle 36 allows for convenient manipulation of the tool so that an inside corner can be finished without removing the tool from the user's hand or inverting the tool to move the tool from the top of an insider corner of a drywall joint to the bottom of the corner.

The apex 38 of the arcuate blade 10 is the highest point of the blade angle 36. However, if a line is drawn in a plane of the length of the blade, the top and bottom edges 32 and 34, respectively, at joint 26 would be about 30° from the line or apex 38 of blade while being in the same plane of the arcuate blade members 12 and 14.

Tool 10 has a handle 40 so that tool 10 can be manipulated with ease by the user. Handle 40 and tool 10 may be made as a unitary member, thereby simplifying construction and costs of the tool. Typically, however, it can be attached to connector member 42, which joins each blade member. Connectors 42 may be attached to blade members 12 and 14 by soldering, rivets, bolts, or any other conventional means that would be compatible with the construction of the tool. Handle 40 can be attached to blade members 12 and 14 by conventional means, including bolts, soldering, etc.

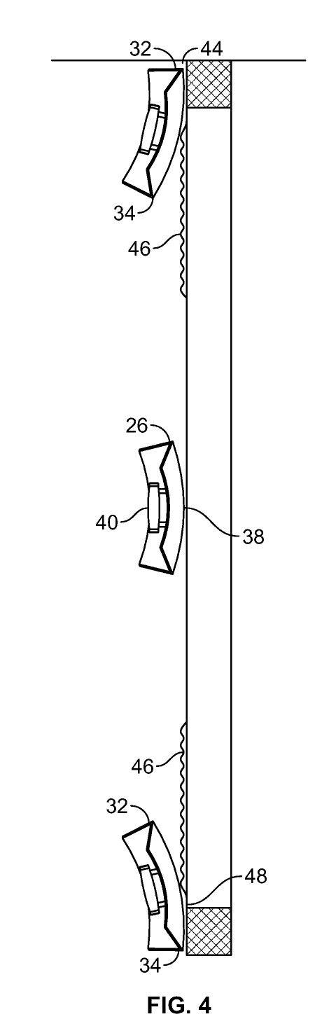

FIG. 4 shows a sectional view of a corner and tool 10 wherein a method of using tool 10 is presented. Top edge 32 of blade members 12 and 14, when starting at one end 44, or the top of the wall, is pressed against joint compound 46 for finishing the corner. Tool 10 is pressed against joint compound 46 in the corner as it is moved downwardly to the second end 48. As tool 10 moves downwardly in the corner, top edge 32 can be pressed against the corner for a smooth, finishing effect. While extending down the corner, apex 38 contacts the corner and is rotated to continuously engage the inside corner. By rotation it is meant that the joint 26 is moved or rocked while continuously engaging the corners from one edge 32 to the other edge 34 or vice versa. As tool 10 is moved further down the corner, apex 38 is rotated or tilted to the second end 48 or bottom of the wall, bottom edge 34 of the blade is firmly pressed in the corner and top edge 32 is lifted in order to complete the smooth finish of the corner. With the arcuate angle 36, the user need not stop at some point between the one end 44 and the second end 48 to change hands and manipulate the handle 40 to second end 48 or bottom of the wall. The tool does not have to be inverted to complete the finishing process. Arcuate angle 36 of the blade member 12 and 14 allows for a more efficient and quicker finishing of a corner than conventional trowels or tools.

The process of moving tool 10 is reversed if the corner is finished from the bottom of the wall or second end 48 to top of the wall or first edge 44. Bottom edge 34 is held firmly against joint compound 46 at the second end or bottom of wall 48 ready for upward movement. As the tool is moved upward it rotates on apex 38 of arcuate angle 36 of the blade to remain in contact with the corner. When it reaches a midpoint in the corner, it may continue up the wall by rotating the apex 38 so the angle 36 of the blade remains in contact with the corner. It is rotated so top edge 32 completes the finishing at top of wall 44.

After joint compound 46 is applied to the corner, the tape (not shown) is applied to the corner. Tool 10 is then positioned in the corner, at the top end 44 or second end 48 and moved in the respective opposite direction in the corner, to its top from second end 48 or to the bottom from top end 44 in the manner previously described. The respective edge 32 or 34 of tool 10 is placed on the tape and moved upwardly or downwardly so apex 38 engages the tape to embed the tape into the joint compound 46. As tool 10 is moved against the tape, it creases the tape and divides the compound 46 so that it is pushed or squeezed from under the tape to outside of the tape onto each wall forming the corner. The action distributes the joint compound 46 onto each wall in relatively uniform amounts. After this procedure is completed, the end of the trowel opposite the direction of movement is utilized to remove the excess joint compound 46 from each wall. For example, starting at the top end 44 of the wall, top edge 32 of blade member 12 is placed on the distributed joint compound 46 on the right sidewall forming the corner. Tool 10 is then moved downwardly removing the excess joint compound 46 in a substantially clean manner forming a clear finish to the wall. This procedure is repeated on the left sidewall of the corner where top edge 32 of blade member 14 contacts the excess joint compound 46. Tool 10 is moved downwardly as previously described to remove joint compound 46.

If the user starts the finishing action from second or bottom end 48, bottom end 34 of blade member 12 is utilized on the right sidewall of the corner to engage excess joint compound 26. Tool 10 is moved upwardly to collect excess joint compound 46 for a smooth surface. The process is repeated on the left sidewall of the corner wherein lower edge 34 engages the joint compound 46 and the collection procedure is repeated for tapering and feathering the compound. The resulting corner is relatively free of joint compound 46 after removal by the tool. This process is repeated when the last layer of joint compound 46 is applied as a finishing coat to the joint. Upon drying and light sanding, the corner is smooth and ready to be painted.

To ease the manipulation of tool 10, the outside corners of outside edges 28 and 30 are offset by about 7° from a level plane at joint 26 in the direction of the outside corners to allow for facile manipulation of blades 12 and 14 by handle 40. The tapering of the top edge 32 and bottom edge 34 of side edges 28 and 30 permits joint 26 to meet the corner of each wall and ceiling or floor for a complete fitting into the corner. The corner walls and ceiling or floor are typically joined at 90° angles.

The present invention has been described with reference to preferred embodiments. However, those skilled in the art will recognize that changes and modifications may be made in the described embodiments without departing from the true nature and scope of the present invention. Various changes and modifications to the embodiments herein chosen for the purpose of illustration will readily occur to those skilled in the art. To the extent that such modification and variations do not depart from the spirit of the invention, they are intended to be included within the scope thereof, which is assessed only by a fair interpretation of the following claims.

What is claimed is:

1. A tool for finishing drywall surfaces where the surfaces are joined to form an inside corner, comprising:
a. first and second elongated blade members, each of said blade members having a first side and a second side defining a blade angle, and top and bottom edges,
b. top, middle and bottom portions on said blade members,
c. a handle connected to the top first side of the blade members, and
d. the blade being arcuate for engaging the inside corner of drywall surfaces.

2. A tool according to claim 1 wherein the arcuate blade allows a user to manipulate the tool to finish joint compound on inside corner drywall surfaces without removing the tool from the drywall surfaces.

3. A tool according to claim 1, wherein the arcuate blade edge has an apex and top and bottom edges of the arcuate blade in the same plane are positioned about 30° from the apex.

4. A tool according to claim 3 wherein the top and bottom edges of the arcuate blade are positioned in the same plane as the apex at an angle of about 30° from the apex.

5. A method of using a tool for finishing drywall surfaces where the surfaces are joined to form an inside corner, including:
a. first and second elongated blade members, each of said blade members having a first and second sides defining a blade angle, and top, bottom, and outside edges,
b. a top, middle, and bottom portions on said first and second blade members,
c. a handle connected to the top first side of the blade members,
d. the blade angle being arcuate for engaging the inside corner of drywall surfaces where the surfaces are joined to form an inside corner, the corner having a first end and a second end, and joint compound applied to the corner, contacting the tool at one end of the corner and moving it to the other end while finishing the joint compound on the corner without removing the trowel from the corner.

6. The method according to claim 5, wherein the arcuate blade edge has an apex.

7. The method according to claim 6 wherein the top and bottom edges of the arcuate blade are positioned in the same plane as the apex at an angle of about 30° from the apex.

8. The method according to claim 5 wherein the joint compound may be a finishing compound, a taping compound or an adhesive.

9. The method according to claim 5, wherein the blade contacts drywall tape.

10. The method according to claim 5, wherein the method allows a user to provide a smooth finish to the corner, wherein the user does not change the grip on the handle.
